(19) United States
(12) Patent Application Publication
(10) Pub. No.: US 2024/0190763 A1
(43) Pub. Date: Jun. 13, 2024

(54) BELITE-YE'ELIMITE-TERNESITE CEMENT CLINKER AND METHOD FOR PREPARING THE SAME

(71) Applicants: China Building Materials Academy Co., Ltd., Beijing (CN); China National Building Material Group Co., Ltd., Beijing (CN)

(72) Inventors: Lixue CAO, Beijing (CN); Xuehong REN, Beijing (CN); Wensheng ZHANG, Beijing (CN); Jiayuan YE, Beijing (CN); Hongtao ZHANG, Beijing (CN); Nan AN, Beijing (CN); Wenjuan CUI, Beijing (CN)

(21) Appl. No.: 18/537,717

(22) Filed: Dec. 12, 2023

Related U.S. Application Data
(63) Continuation-in-part of application No. PCT/CN2023/110595, filed on Aug. 1, 2023.

(30) Foreign Application Priority Data
Dec. 7, 2022 (CN) 202211564190.0

(51) Int. Cl. C04B 7/345; C04B 7/43; C04B 7/52; C04B 11/30

(52) U.S. Cl. CPC C04B 7/3453; C04B 7/434; C04B 7/52; C04B 11/30

(57) ABSTRACT

A belite-ye'elimite-ternesite cement clinker includes: ye'elimite: 20-50 wt. %; ternesite: 24-50 wt. %; belite: 10-35 wt. %; and free-calcium sulfate (f-C$): 2-10 wt. %. The composition of cement clinker includes an appropriate amount of ye'elimite minerals, ensuring fast early hydration and high early strength of the cement clinker. The cement clinker further includes a certain amount of free-calcium sulfate (f-C$), and is characterized by its good grindability, leading to decreased energy and mechanical losses essential for clinker grinding. This environmentally conscious and energy-efficient method aligns with the global objective of reducing carbon emissions.

### CROSS-REFERENCE TO RELATED APPLICATIONS

This application is a continuation-in-part of International Patent Application No. PCT/CN2023/110595 with an international filing date of Aug. 1, 2023, designating the United States, now pending, further claims foreign priority benefits to Chinese Patent Application No. 202211564190.0 filed Dec. 7, 2022. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of construction material technology, and more particularly, to a belite-ye'elimite-ternesite cement clinker, a cement and a method for preparing the same.

Calcium sulfoaluminate (CSA) cement clinker is prepared through low-temperature calcination of raw materials such as limestone, bauxite, and calcium sulfate. The predominant minerals within are calcium sulfoaluminate (C₄A₃$, Ye'elimite) and dicalcium silicate (C₂S, Belite), showcasing qualities such as high early strength, rapid setting, low alkalinity, minor expansion, good erosion resistance, and resistance to freezing. Because the calcium sulfoaluminate cement clinker is characterized by its relatively high content of the C₄A₃$ mineral, the preparation process requires the use of high-quality bauxite with elevated aluminum content as the raw material. This elevation in production materials raises the cost of the calcium sulfoaluminate cement clinker, thereby posing difficulties for the extensive adoption of calcium sulfoaluminate cement.

Recent research has revealed that calcium sulfosilicate (C₅S₂$, Ternesite) exhibits stronger hydration reactivity within the calcium sulfoaluminate system. When compared to beta-dicalcium silicate (β-C₂S). C₅S₂$ develops within a temperature range of 900-1200° C., and when the temperatures exceed 1200° C., it decomposes into C₂S and CaSO₄. The most suitable temperature range for the calcination of C₄A₃$ is 1300-1350° C., which poses a difficulty in achieving stable calcination for ye'elimite-ternesite clinker. At present, two main methods are utilized for the calcination of ye'elimite-ternesite cement clinker: one method involves a “secondary calcination” technique, wherein the cement clinker is firstly calcined at 1300° C.-1350° C.; subsequently, after complete formation of C₄A₃$, a low-temperature (1100-1200° C.) secondary calcination process is performed; although this method ensures the development and reactivity of C₄A₃$, it is intricate and challenging to put into practice within an industrial context. Another method involves the direct calcination of the raw materials at a low temperature of 1150-1200° C. for 30-120 minutes to form the ye'elimite-ternesite cement clinker; however, this process results in low content of ternesite in the cement clinker and the potential occurrence of mayenite (C₁₂A₇), a mineral that experiences rapid hydration and releases substantial heat; this circumstance results in challenges related to clinker formation and the achievement of satisfactory strength; furthermore, the low temperature calcination process yields C₄A₃$ with limited reactivity, impeding the growth of the strength of the cement clinker. Therefore, a method for preparing a belite-ye'elimite-ternesite cement clinker is needed.

In the construction industry, phosphogypsum finds its primary application in substituting gypsum within the cement and in the production of the calcium sulfate for construction. However, introducing phosphogypsum into cement concrete can result in adverse consequences, such as reduced mechanical strength of the matrix, increased expansion, and decreased workability. Moreover, owing to the existence of phosphorus impurities (both soluble and eutectic), fluoride impurities, and organic compounds within phosphogypsum, direct incorporation is unfeasible, necessitating processes like calcination, lime neutralization, and washing to remove impurities prior to its utilization. When contrasted with conventional paint materials, phosphogypsum-based plastering materials offer enhanced durability and resistance to cracking.

However, the formulation of these materials generally entails several additives, leading to increased production costs and constraining their use within industries. Therefore, there is a requirement for additional advancement in the utilization of phosphogypsum.

Based on the above analysis, the optimization and enhancement of the formulation and preparation method of belite-ye'elimite-ternesite cement clinker can enhance clinker performance, simplify processes, reduce CO₂ emissions, and lower costs. This optimization poses an urgent technical challenge within this industry.

### SUMMARY

To solve the aforesaid problems, the first objective of the disclosure is to provide a belite-ye'elimite-ternesite cement clinker that exhibits excellent hydration reactivity and high strength both in the early and later stages.

The second objective of the disclosure is to provide a method for preparing the belite-ye'elimite-ternesite cement clinker. The method increases the content of ternesite content and enhances the reactivity of ye'elimite, inhibiting the formation of mayenite and ultimately improving performance of the cement during both the early and later-stages.

To achieve these objectives, the disclosure adopts the following technical solutions:

The belite-ye'elimite-ternesite cement clinker comprises:
ye'elimite: 20-50 wt. %;
ternesite: 24-50 wt. %;
belite: 10-35 wt. %;
free-calcium sulfate (f-C$): 2-10 wt. %.

In a class of this embodiment, the belite-ye'elimite-ternesite cement clinker comprises:
ye'elimite: 40-43 wt. %;
ternesite: 24-35 wt. %;
belite: 15-25 wt. %;

free-calcium sulfate (f-C$): 3-5 wt. %.

Preferably, cubic ye'elimite accounts for 9-15 wt. % of the cement clinker.

Preferably, α-C₂S accounts for 1-3 wt. % of the cement clinker.

Preferably, a mass ratio of belite to ternesite is 0.25-1, and a mass ratio of ternesite to ye'elimite is 0.5-1.

In a class of this embodiment, raw materials of the cement clinker comprise 40-65 wt. % of limestone, 15-30 wt. % of phosphogypsum, 5-20 wt. % of fly ash, and 5-25 wt. % of aluminum source.

In a class of this embodiment, raw materials of the cement clinker comprise 48-52 wt. % of limestone, 18-24 wt. % of phosphogypsum, 9-15 wt. % of fly ash, and 18-21 wt. % of aluminum source.

In a class of this embodiment, the aluminum source is an industrial waste comprising more than 40 wt. % aluminum; and the industrial waste comprises low-grade bauxite, alumina ash, high-alumina fly ash, or a combination thereof.

In a class of this embodiment, the limestone comprises 50-60 wt. % CaO.

In a class of this embodiment, the phosphogypsum comprises 40-50 wt. % SO₃.

In a class of this embodiment, the fly ash comprises 40-60 wt. % SiO₂ and 30-35 wt. % Al₂O₃.

In a class of this embodiment, the raw materials of the cement clinker comprise the following main chemical compositions:
limestone comprising 0.61 wt. % of SiO₂, 0.05 wt. % of Al₂O₃, 0.19 wt. % of Fe₂O₃, 55.9 wt. % of CaO, 0.01 wt. % of MgO, and 0.42 wt. % of SO₃, with a loss on ignition of 42.64;
phosphogypsum comprising 1.44 wt. % of SiO₂, 1.19 wt. % of Al₂O₃, 0.62 wt. % of Fe₂O₃, 33.93 wt. % of CaO, 0.31 wt. % of MgO, and 47.04 wt. % of SO₃, with a loss on ignition of 15.45;
fly ash comprising 52.47 wt. % of SiO₂, 34.02 wt. % of Al₂O₃, 2.92 wt. % of Fe₂O₃, 4.80 wt. % of CaO, 0.69 wt. % of MgO, and 0.27 wt. % of SO₃, with a loss on ignition of 2.32;
low grade bauxite comprising 21.72 wt. % of SiO₂, 52.40 wt. % of Al₂O₃, and 7.63 wt. % of Fe₂O₃, with a loss on ignition of 16.00;
alumina ash comprising 27.20 wt. % of SiO₂, 56.16 wt. % of Al₂O₃, 12.49 wt. % of Fe₂O₃, 5.62 wt. % of CaO, 2.80 wt. % of MgO, and 0.78 wt. % of SO₃, with a loss on ignition of −6.01; and
high-alumina fly ash comprising 40.24 wt. % of SiO₂, 48.30 wt. % of Al₂O₃, 2.70 wt. % of Fe₂O₃, 3.17 wt. % of CaO, 0.03 wt. % of MgO, and 0.64 wt. % of SO₃, with a loss on ignition of 2.16.

The method for preparing the belite-ye'elimite-ternesite cement clinker, and the method comprising:
(1) individually grinding the raw materials of the cement clinker; weighting the ground raw materials according to mass percentages; thoroughly mixing the ground raw materials to obtain a raw mixture; pressing the raw mixture into a cake and then drying the cake to obtain a raw clinker cake; and
(2) calcining the raw clinker cake; cooling the calcined raw clinker cake to room temperature; and grinding the cooled raw clinker cake to obtain a cement clinker.

In a class of this embodiment, in (1), the raw materials are ground to a particle size of ≤0.075 mm.

In a class of this embodiment, in (1), the ground raw materials are thoroughly mixed for 6-9 hours using a mixer.

In a class of this embodiment, in (2), the process of calcination comprises heating the raw clinker cake to 1200-1250° C. at a heating rate of 5-10° C./min, and maintaining the temperature for 60-120 minutes.

In a class of this embodiment, in (2), the calcined raw materials are rapidly cooled using a wind cooling method.

The third objective of the disclosure is to provide a cement comprising the abovementioned belite-ye'elimite-ternesite cement clinker and calcium sulfate.

In a class of this embodiment, an amount of the calcium sulfate is calculated according to a molar ratio of ye'elimite within the cement clinker to SO₃ contained in the calcium sulfate and subtracting the amount of free-calcium sulfate (f-C$) in the cement clinker.

In a class of this embodiment, the molar ratio of ye'elimite within the cement clinker to SO₃ contained in the calcium sulfate is determined according to the specification of the cement.

In a class of this embodiment, the calcium sulfate comprises phosphogypsum, gypsum, anhydrite, desulfurization gypsum, or a combination thereof.

The following advantages are associated with the disclosure.

1. The cement clinker comprises ye'elimite at 20-50 wt. %, ternesite at 24-50 wt. %, dicalcium silicate at 10-35 wt. %, and free-calcium sulfate (f-C$) at 2-10 wt. %.

The composition of cement clinker comprises an appropriate amount of ye'elimite minerals, ensuring fast early hydration and high early strength of the cement clinker.

Compared to the conventional cement clinkers of the same type, the disclosed cement clinker showcases an elevated content of ternesite while decreasing the content of dicalcium silicate. The higher reactivity of ternesite in comparison to dicalcium silicate leads to the disclosed cement clinker maintaining its strength growth throughout the later stages of curing, thereby enhancing the late-stage strength of the cement.

Further, the disclosed cement clinker comprises ye'elimite at 40-43 wt. %, ternesite at 24-35 wt. %, belite at 15-25 wt. %, and free-calcium sulfate (f-C$) at 3-5 wt. %. The cement clinker with such composition exhibits positive hydration reactivity and strength growth, leading to high strength in both the early and later curing stages, thereby meeting engineering standards.

2. The cement clinker further comprises a substantial quantity of highly reactive cubic ye'elimite (c-C₄A₃$), constituting around ¼ of the total C₄A₃$ content. The increase in c-C₄A₃$ content enhances the early-stage strength development of the cement clinker. Additionally, the cement clinker comprises α-C₂S, which exhibits increased reactivity in comparison to β-C₂S. The interaction between α-C₂S and C₅S₂$ contributes to the advancement of strength as the cement clinker matures.

3. The cement clinker comprises limestone at 40-65 wt. %, phosphogypsum at 15-30 wt. %, fly ash at 5-20 wt. %, and aluminum source at 5-25 wt. %. Adjusting the quantity of phosphogypsum in the raw materials allows for the regulation of free-calcium sulfate (f-C$) content in the cement clinker. Introducing an appropriate measure of fly ash promotes the formation and steadiness of highly reactive ternesite. This process yields a cement clinker featuring elevated ternesite levels and reduced belite content, leading to improved reactivity of the cement clinker. The addition of a small amount of an aluminum source contributes to produce a restricted amount of ye'elimite minerals, ensuring favorable early-stage performance of the clinker. Moreover, compared to conventional Portland cement clinkers, the reduced calcium content in the cement clinker reduced the demand for limestone, resulting in decreased CO₂ emissions.

4. The cement clinker uses low-grade bauxite as a raw material, which is more accessible than high-grade bauxite. Low-grade bauxite, with low alumina content and impurities is often underutilized. Utilizing low-grade bauxite as a raw material allows for recycling industrial waste, conserving resource, and cutting clinker production costs of the cement clinker.

The cement clinker comprises industrial by-products such as fly ash, phosphogypsum, and aluminum ash used as raw materials. These raw materials are easily accessible and affordable, leading to the cost reductions in cement clinker production. Additionally, up to 30 wt. % of phosphogypsum can be incorporated, which corresponds to 0.3 tons of phosphogypsum per ton of the cement clinker. The broad implementation of the cement clinker has dual benefits: diminishing the accumulation of phosphogypsum waste and elevating resource utilization efficiency within the cement industry.

5. The cement clinker is produced through a calcination process at temperatures ranging from 1200 to 1250° C. The calcination temperatures are reduced by 200-250° C. compared to Ordinary Portland cement (OPC), and by 50-150° C. compared to calcium sulfoaluminate cement. The reduction in temperature brings benefits such as decreased energy consumption during production and improved mineral reactivity within the cement clinker. Consequently, the disclosed method enhances the performance of the cement in both early and late stages.

In the calcination step, the disclosed method utilizes a heating rate that varies between 5 and 10° C./min. The speed facilitates the thorough development and maturity of ternesite within the cement clinker. The resulting cement clinker exhibits a higher content of ternesite and reduced belite content. The cement clinker further comprises a certain amount of free-calcium sulfate (f-C$), and is characterized by its good grindability, leading to decreased energy and mechanical losses essential for clinker grinding. This environmentally conscious and energy-efficient method aligns with the global objective of reducing carbon emissions.

### BRIEF DESCRIPTION OF THE DRAWINGS

FIG. 1 shows an XRD pattern of a cement clinker according to Example 1 of the disclosure. Herein, Y for Ye'elimite (C₄A₃$), T for Ternesite (C₅S₂$), B1 for Belite (β-C₂S), B2 for Belite (α-C₂S), and A for Anhydride (C$);

FIG. 2 shows an XRD pattern of a cement clinker according to Example 2 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$);

FIG. 3 shows an XRD pattern of a cement clinker according to Example 3 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$);

FIG. 4 shows an XRD pattern of a cement clinker according to Example 4 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$);

FIG. 5 shows an XRD pattern of a cement clinker according to Example 5 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$);

FIG. 6 shows an XRD pattern of a cement clinker according to Example 6 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$);

FIG. 7 shows an XRD pattern of a cement clinker according to Comparison Example 1 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$);

FIG. 8 shows an XRD pattern of a cement clinker according to Comparison Example 2 of the disclosure. Herein, Y for Ye'elimite (C₄A₃$), T for Ternesite (C₅S₂$), B1 for Belite (β-C₂S), B2 for Belite (α-C₂S), and A for free-anhydride (f-C$); and

FIG. 9 shows mortar strengths at different time point (1-day, 3-day, 7-day, 28-day, and 90-day) of the cement prepared in Examples 1-6 and Comparison Examples 1-2, and a reference cement.

### DETAILED DESCRIPTION

To further illustrate the disclosure, embodiments detailing a belite-ye'elimite-ternesite cement clinker and a method for preparing the same are described below. It should be noted that the following embodiments are intended to describe and not to limit the disclosure.

For embodiments lacking specific experimental details, standard procedures as described in the field's literature can be used. Unspecified materials or instruments are common products available for purchase.

In the following examples and comparisons, Table 1 lists the main chemical compositions of raw materials. These listed materials are exemplars and should not be viewed as constraints on the disclosure.

TABLE 1
Main chemical composition of raw materials

| | Loss on | SiO₂ | Al₂O₃ | Fe₂O₃ | CaO | MgO | SO₃ |
|---|---|---|---|---|---|---|---|
| | Ignition | (wt. | (wt. | (wt. | (wt. | (wt. | (wt. |
| | (LOI) | %) | %) | %) | %) | %) | %) |
| Limestone | 42.64 | 0.61 | 0.05 | 0.19 | 55.9 | 0.01 | 0.42 |
| Phospho- | 15.45 | 1.44 | 1.19 | 0.62 | 33.93 | 0.31 | 47.04 |
| gypsum | | | | | | | |
| Fly ash | 2.32 | 52.47 | 34.02 | 2.92 | 4.80 | 0.69 | 0.27 |
| Low-grade | 16.00 | 21.72 | 52.40 | 7.63 | / | / | / |
| bauxite | | | | | | | |
| Alumina ash | −6.01 | 27.20 | 56.16 | 12.49 | 5.62 | 2.80 | 0.78 |
| High-alumina | 2.16 | 40.24 | 48.30 | 2.70 | 3.17 | 0.03 | 0.64 |
| fly ash | | | | | | | |

### Example 1

A belite-ye'elimite-ternesite cement clinker comprises the following raw materials:

460 g of limestone, 260 g of phosphogypsum, 70 g of fly ash, and 210 g of low-grade bauxite. The main chemical compositions of each raw material were listed in Table 1.

A method for preparing the belite-ye'elimite-ternesite cement clinker, and the method comprises:
(1) the raw materials were dried at 105° C. for 24 hours to remove moisture, then finely ground using a grinder to a particle size of ≤0.075 mm; the ground raw materials were weighted based on the amounts described above and mixed in a mixer for 7.5 hours to form a raw mixture;
(2) 14 mL of alcohol was added to 200 g of the raw mixture and mixed thoroughly; the resulting mixture was placed into a grinding and pressing machine and compressed under a pressure of 20 MPa to form a corrugated circular disk with a diameter of 10 cm and a thickness of 0.8 cm; the corrugated circular disk was then dried in a drying oven at 105° C. for 6 hours to produce a raw clinker cake;
(3) the raw clinker cake was subjected to high-temperature heating using an electric furnace with a silicon molybdenum rod; the temperature was gradually raised to 1230° C. at a rate of 9.9° C./min and held at the temperature for 80 minutes; subsequently, the calcined clinker cake was quickly cooled to room temperature using forced air, thereby producing a clinker block; and
(4) the cooled clinker block was crushed and ground to a fineness of 0.045 mm, ensuring that no more than 9% of the residue remained on a sieve, thereby obtaining a belite-ye'elimite-ternesite cement clinker.

Using the Topas software, the composition of the cement clinker obtained in Example 1 was determined as follows: ye'elimite at 38.97 wt. %, ternesite at 42.18 wt. %, belite at 10.49 wt. %, and free-calcium sulfate (f-C$) at 4.32 wt. %.

Within the cement clinker, the proportion of cubic ye'elimite within the cement clinker was 9.95 wt. %; the proportion of α-C₂S within the cement clinker was 2.34 wt. %; the mass ratio of belite to ternesite was 0.25; and the mass ratio of ternesite to ye'elimite was 1.08.

Example 1 further provides a method for preparing a belite-ye'elimite-ternesite cement, and the method is described as follows: 150 g of the cement clinker obtained in Example 1 was blend with 0.05 g of phosphogypsum (with an SO₃ content of 47.04 wt. %); the molar ratio of ye'elimite within the cement clinker to SO₃ in phosphogypsum was maintained at 2:1; and the amount of phosphogypsum to be added was determined by subtracting the amount of free-calcium sulfate (f-C$) in the cement clinker from the molar ratio of 2:1.

### Example 2

A belite-ye'elimite-ternesite cement clinker comprises the following raw materials:

490 g of limestone, 220 g of phosphogypsum, 90 g of fly ash, and 200 g of low-grade bauxite. The main chemical compositions of each raw material were listed in Table 1.

A method for preparing the belite-ye'elimite-ternesite cement clinker, and the method comprises:
(1) the raw materials were dried at 105° C. for 24 hours to remove moisture, then finely ground using a grinder to a particle size of ≤0.075 mm; the ground raw materials were weighted based on the amounts described above and mixed in a mixer for 6 hours to form a raw mixture;
(2) 14 mL of alcohol was added to 200 g of the raw mixture and mixed thoroughly; the resulting mixture was placed into a grinding and pressing machine and compressed under a pressure of 20 MPa to form a corrugated circular disk with a diameter of 10 cm and a thickness of 0.7 cm; the corrugated circular disk was then dried in a drying oven at 105° C. for 6 hours to produce a raw clinker cake;
(3) the raw clinker cake was subjected to high-temperature heating using an electric furnace with a silicon molybdenum rod; the temperature was gradually raised to 1250° C. at a rate of 5° C./min and held at the temperature for 120 minutes; subsequently, the calcined clinker cake was quickly cooled to room temperature using forced air, thereby producing a clinker block; and
(4) the cooled clinker block was crushed and ground to a fineness of 0.045 mm, ensuring that no more than 9% of the residue remained on a sieve, thereby obtaining a belite-ye'elimite-ternesite cement clinker.

Using the Topas software, the composition of the cement clinker obtained in Example 2 was determined as follows: ye'elimite at 40.96 wt. %, ternesite at 33.29 wt. %, belite at 16.86 wt. %, and free-calcium sulfate (f-C$) at 4.32 wt. %.

Within the cement clinker, the proportion of cubic ye'elimite within the cement clinker was 10.80 wt. %; the proportion of αC₂S within the cement clinker was 1.38 wt. %; the mass ratio of C₂S to ternesite was 0.51; and the mass ratio of ternesite to ye'elimite was 0.81.

Example 2 further provides a method for preparing a belite-ye'elimite-ternesite cement, and the method is described as follows: 150 g of the cement clinker obtained in Example 2 was blend with 0.92 g of gypsum (with an SO₃ content of 23.69 wt. %); the molar ratio of ye'elimite within the cement clinker to SO₃ in gypsum was maintained at 2:1; and the amount of gypsum to be added was determined by subtracting the amount of free-calcium sulfate (f-C$) in the cement clinker from the molar ratio of 2:1.

### Example 3

A belite-ye'elimite-ternesite cement clinker comprises the following raw materials:

520 g of limestone, 200 g of phosphogypsum, 120 g of fly ash, and 180 g of low-grade bauxite. The main chemical compositions of each raw material were listed in Table 1.

A method for preparing the belite-ye'elimite-ternesite cement clinker, and the method comprises:
(1) the raw materials were dried at 105° C. for 24 hours to remove moisture, then finely ground using a grinder to a particle size of ≤0.075 mm; the ground raw materials were weighted based on the amounts described above and mixed in a mixer for 9 hours to form a raw mixture;
(2) 14 mL of alcohol was added to 200 g of the raw mixture and mixed thoroughly; the resulting mixture was placed into a grinding and pressing machine and compressed under a pressure of 20 MPa to form a corrugated circular disk with a diameter of 10 cm and a thickness of 0.5 cm; the corrugated circular disk was then dried in a drying oven at 105° C. for 6 hours to produce a raw clinker cake;
(3) the raw clinker cake was subjected to high-temperature heating using an electric furnace with a silicon molybdenum rod; the temperature was gradually raised to 1210° C. at a rate of 7.5° C./min and held at the temperature for 60 minutes; subsequently, the calcined clinker cake was quickly cooled to room temperature using forced air, thereby producing a clinker block; and
(4) the cooled clinker block was crushed and ground to a fineness of 0.045 mm, ensuring that no more than 9% of the residue remained on a sieve, thereby obtaining a belite-ye'elimite-ternesite cement clinker.

Using the Topas software, the composition of the cement clinker obtained in Example 3 was determined as follows: ye'elimite at 42.89 wt. %, ternesite at 24.8 wt. %, belite at 24.52 wt. %, and free-calcium sulfate (f-C$) at 3.64 wt. %.

Within the cement clinker, the proportion of cubic ye'elimite within the cement clinker was 13.28 wt. %; the proportion of α-C₂S within the cement clinker was 1.77 wt. %; the mass ratio of belite to ternesite was 0.99; and the mass ratio of ternesite to ye'elimite was 0.58.

Example 3 further provides a method for preparing a belite-ye'elimite-ternesite cement, and the method is described as follows: 150 g of the cement clinker obtained in Example 3 was blend with 2.06 g of anhydrite (with an SO₃ content of 48.89 wt. %); the molar ratio of ye'elimite within the cement clinker to SO₃ in anhydrite was maintained at 2:1; and the amount of anhydrite to be added was determined by subtracting the amount of free-calcium sulfate (f-C$) in the cement clinker from the molar ratio of 2:1.

### Example 4

A belite-ye'elimite-ternesite cement clinker comprises the following raw materials:

520 g of limestone, 200 g of phosphogypsum, 100 g of fly ash, and 180 g of alumina ash. The main chemical compositions of each raw material were listed in Table 1.

A method for preparing the belite-ye'elimite-ternesite cement clinker, and the method comprises:
(1) the raw materials were dried at 105° C. for 24 hours to remove moisture, then finely ground using a grinder to a particle size of ≤0.075 mm; the ground raw materials were weighted based on the amounts described above and mixed in a mixer for 8 hours to form a raw mixture;
(2) 14 mL of alcohol was added to 200 g of the raw mixture and mixed thoroughly; the resulting mixture was placed into a grinding and pressing machine and compressed under a pressure of 20 MPa to form a corrugated circular disk with a diameter of 10 cm and a thickness of 0.9 cm; the corrugated circular disk was then dried in a drying oven at 105° C. for 6 hours to produce a raw clinker cake;
(3) the raw clinker cake was subjected to high-temperature heating using an electric furnace with a silicon molybdenum rod; the temperature was gradually raised to 1240° C. at a rate of 6° C./min and held at the temperature for 110 minutes; subsequently, the calcined clinker cake was quickly cooled to room temperature using forced air, thereby producing a clinker block; and
(4) the cooled clinker block was crushed and ground to a fineness of 0.045 mm, ensuring that no more than 9% of the residue remained on a sieve, thereby obtaining a belite-ye'elimite-ternesite cement clinker.

Using the Topas software, the composition of the cement clinker obtained in Example 4 was determined as follows: ye'elimite at 37.23 wt. %, ternesite at 39.23 wt. %, belite at 14.71 wt. %, and free-calcium sulfate (f-C$) at 4.12 wt. %.

Within the cement clinker, the proportion of cubic ye'elimite within the cement clinker was 9.18 wt. %; the proportion of α-C₂S within the cement clinker was 1.68 wt. %; the mass ratio of belite to ternesite was 0.40; and the mass ratio of ternesite to ye'elimite was 1.05.

Example 4 further provides a method for preparing a belite-ye'elimite-ternesite cement, and the method is described as follows: 200 g of the cement clinker obtained in Example 4 was blend with 0.17 g of desulfogypsum (with an SO₃ content of 21.47 wt. %); the molar ratio of ye'elimite within the cement clinker to SO₃ in desulfogypsum was maintained at 2:1; and the amount of desulfogypsum to be added was determined by subtracting the amount of free-calcium sulfate (f-C$) in the cement clinker from the molar ratio of 2:1.

### Example 5

A belite-ye'elimite-ternesite cement clinker comprises the following raw materials:

570 g of limestone, 210 g of phosphogypsum, 60 g of fly ash, and 200 g of high-alumina fly ash. The main chemical compositions of each raw material were listed in Table 1.

A method for preparing the belite-ye'elimite-ternesite cement clinker, and the method comprises:
(1) the raw materials were dried at 105° C. for 24 hours to remove moisture, then finely ground using a grinder to a particle size of ≤0.075 mm; the ground raw materials were weighted based on the amounts described above and mixed in a mixer for 7 hours to form a raw mixture;
(2) 14 mL of alcohol was added to 200 g of the raw mixture and mixed thoroughly; the resulting mixture was placed into a grinding and pressing machine and compressed under a pressure of 20 MPa to form a corrugated circular disk with a diameter of 10 cm and a thickness of 1 cm; the corrugated circular disk was then dried in a drying oven at 105° C. for 6 hours to produce a raw clinker cake;
(3) the raw clinker cake was subjected to high-temperature heating using an electric furnace with a silicon molybdenum rod; the temperature was gradually raised to 1220° C. at a rate of 8.5° C./min and held at the temperature for 100 minutes; subsequently, the calcined clinker cake was quickly cooled to room temperature using forced air, thereby producing a clinker block; and
(4) the cooled clinker block was crushed and ground to a fineness of 0.045 mm, ensuring that no more than 9% of the residue remained on a sieve, thereby obtaining a belite-ye'elimite-ternesite cement clinker.

Using the Topas software, the composition of the cement clinker obtained in Example 5 was determined as follows: ye'elimite at 37.89 wt. %, ternesite at 40.06 wt. %, belite at 13.85 wt. %, and free-calcium sulfate (f-C$) at 2.07 wt. %.

Within the cement clinker, the proportion of cubic ye'elimite within the cement clinker was 9.21 wt. %; the proportion of α-C₂S within the cement clinker was 1.51 wt. %; the mass ratio of belite to ternesite was 0.35; and the mass ratio of ternesite to ye'elimite was 1.06.

Example 5 further provides a method for preparing a belite-ye'elimite-ternesite cement, and the method is described as follows: 200 g of the cement clinker obtained in Example 5 was blend with 5.39 g of phosphogypsum (with an SO₃ content of 47.04 wt. %); the molar ratio of ye'elimite within the cement clinker to SO₃ in phosphogypsum was maintained at 2:1; and the amount of phosphogypsum to be added was determined by subtracting the amount of free-calcium sulfate (f-C$) in the cement clinker from the molar ratio of 2:1.

### Example 6

A belite-ye'elimite-ternesite cement clinker comprises the following raw materials:

490 g of limestone, 220 g of phosphogypsum, 90 g of fly ash, and 200 g of low-grade bauxite. The main chemical compositions of each raw material were listed in Table 1.

A method for preparing the belite-ye'elimite-ternesite silicate cement clinker, and the method comprises:
(1) the raw materials were dried at 105° C. for 24 hours to remove moisture, then finely ground using a grinder to a particle size of ≤0.075 mm; the ground raw materials were weighted based on the amounts described above and mixed in a mixer for 6 hours to form a raw mixture;
(2) 14 mL of alcohol was added to 200 g of the raw mixture and mixed thoroughly; the resulting mixture was placed into a grinding and pressing machine and compressed under a pressure of 20 MPa to form a corrugated circular disk with a diameter of 10 cm and a thickness of 0.7 cm; the corrugated circular disk was then dried in a drying oven at 105° C. for 6 hours to produce a raw clinker cake;
(3) the raw clinker cake was subjected to high-temperature heating using an electric furnace with a silicon molybdenum rod; the temperature was gradually raised to 1250° C. at a rate of 10° C./min and held at the temperature for 120 minutes; subsequently, the calcined clinker cake was quickly cooled to room temperature using forced air, thereby producing a clinker block; and
(4) the cooled clinker block was crushed and ground to a fineness of 0.045 mm, ensuring that no more than 9% of the residue remained on a sieve, thereby obtaining a belite-ye'elimite-ternesite cement clinker.

Using the Topas software, the composition of the cement clinker obtained in Example 6 was determined as follows: ye'elimite at 41.86 wt. %, ternesite at 33.39 wt. %, belite at 17.75 wt. %, and free-calcium sulfate (f-C$) at 4.43 wt. %.

Within the cement clinker, the proportion of cubic ye'elimite within the cement clinker was 10.57 wt. %; the proportion of α-C₂S within the cement clinker was 1.34 wt. %; the mass ratio of belite to ternesite was 0.53; and the mass ratio of ternesite to ye'elimite was 0.80.

Example 6 further provides a method for preparing a belite-ye'elimite-ternesite cement, and the method is described as follows: 150 g of the cement clinker obtained in Example 6 was blend with 0.88 g of anhydrite (with an SO₃ content of 23.69 wt. %); the molar ratio of ye'elimite within the cement clinker to SO₃ in the anhydrite was maintained at 2:1; and the amount of anhydrite to be added was determined by subtracting the amount of free-calcium sulfate (f-C$) in the cement clinker from the molar ratio of 2:1.

### Comparison Example 1

Comparison Example 1 is identical to Example 2, except for one difference:

The raw clinker cake was calcined at 1200° C.

Using the Topas software, the composition of the cement clinker obtained in Comparison Example 1 was determined as follows: ye'elimite at 35.81 wt. %, ternesite at 50.14 wt. %, belite at 10.58 wt. %, and free-calcium sulfate (f-C$) at 0.94 wt. %.

Within the cement clinker, the proportion of cubic ye'elimite within the cement clinker was 4.55 wt. %; the proportion of α-C₂S within the cement clinker was 0.74 wt. %; the mass ratio of belite to ternesite was 0.21; and the mass ratio of ternesite to ye'elimite was 1.4.

### Comparison Example 2

Comparison Example 2 replicates Example 2 from Chinese Patent CN114213043A, following a specific method for preparing a cement clinker: fly ash, phosphogypsum, limestone, and bauxite were dried at 100° C. for 24 hours, then ground into particles with a fineness of ≤200 mesh; a mixture containing 580 g of limestone, 103.3 g of phosphogypsum, 206.1 g of fly ash, and 110.6 g of bauxite were thoroughly blend in a mixer for 12 hours; subsequently, 20 g of the resulting mixture was compressed into a circular disc with a diameter of 20 mm under a pressure of 20 MPa; the circular disc was then placed in a box-type resistance furnace, heated to 1150° C. at a rate of 10° C./min, held for 30 minutes, and rapidly cooled using air flow; and the resulting cooled clinker block was further crushed to achieve a fineness of 200 mesh.

Utilizing the Topas software, the composition of the cement clinker obtained in Comparison Example 2 was determined as follows: ye'elimite at 34 wt. %, ternesite at 12.6 wt. %, belite at 48.5 wt. %, and mayenite at 1.10 wt. %. Within the cement clinker, the mass ratio of belite to ternesite was 3.85; and the mass ratio of ternesite to ye'elimite was 0.37. No free-calcium sulfate (f-C$), cubic ye'elimite, and α-C₂S were detected.

### Experimental Example

### Structural Determination

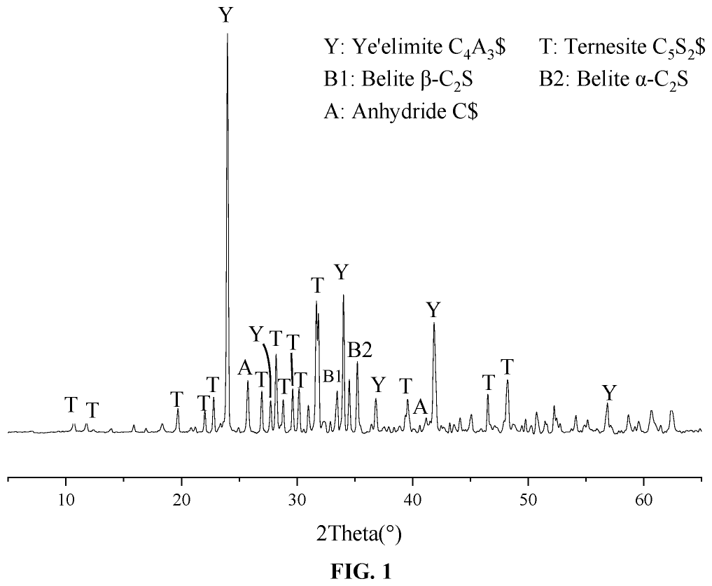

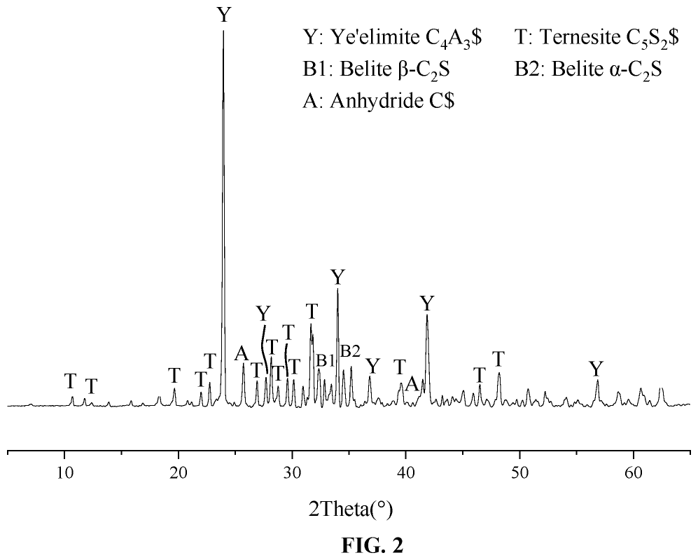

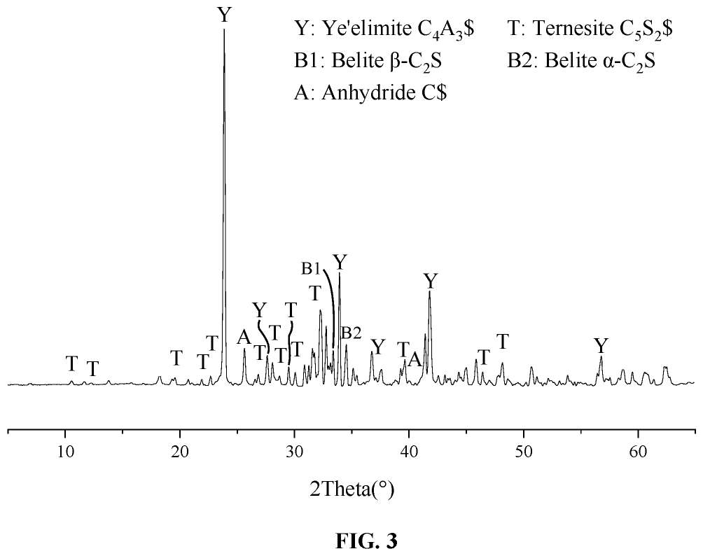

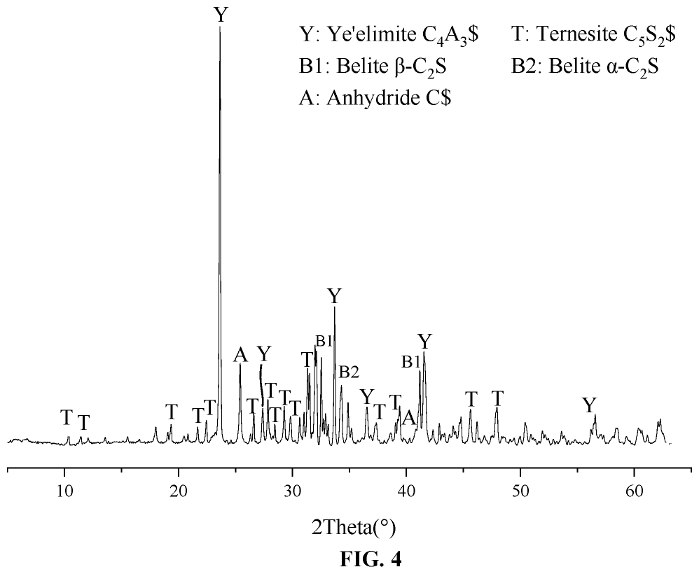

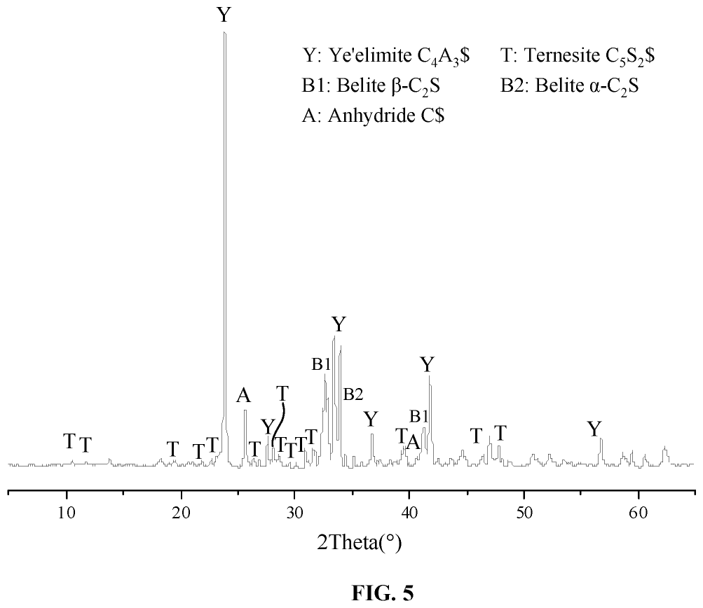

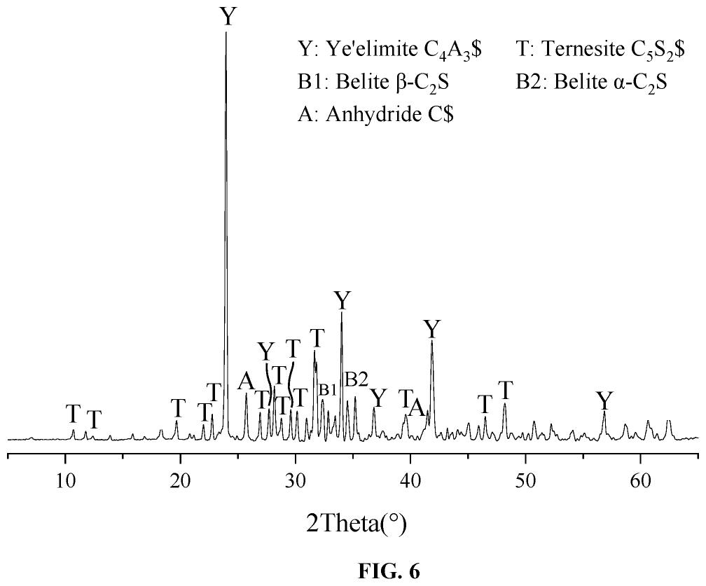

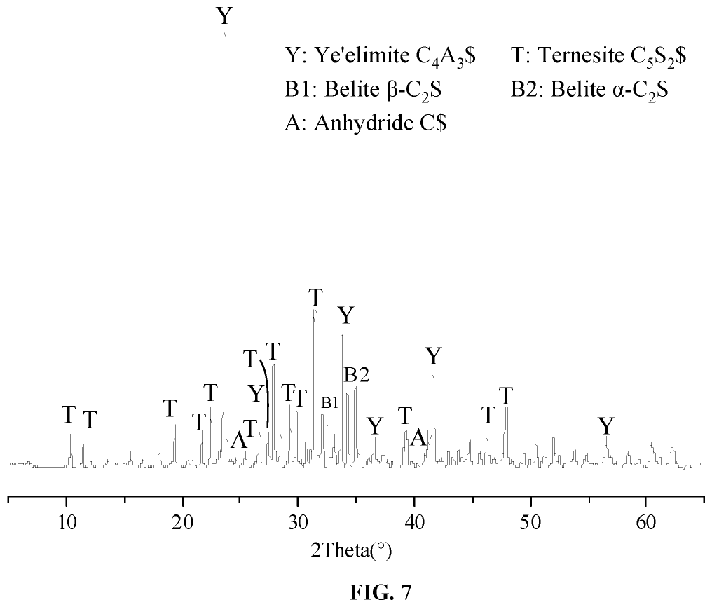

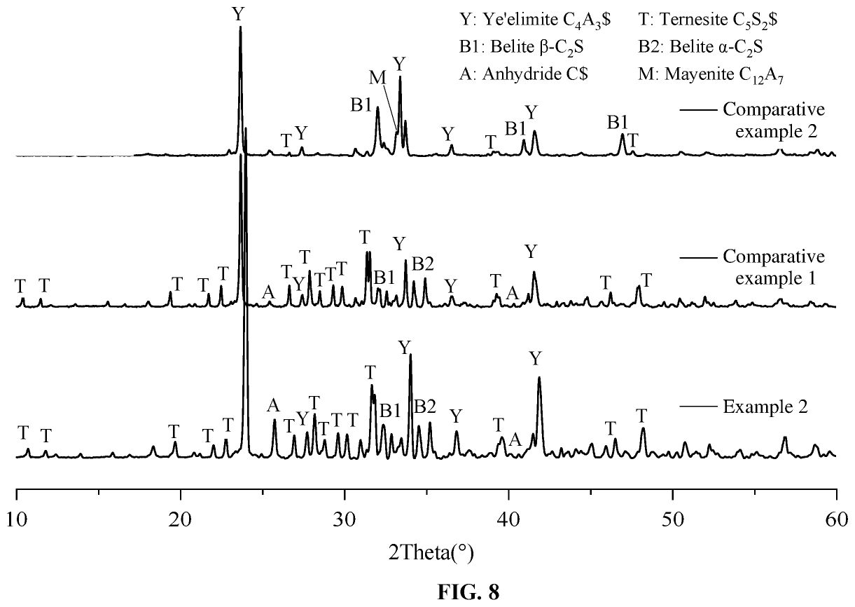

X-ray diffraction analysis was conducted on the cement clinkers prepared in Examples 1-6 and Comparison Examples 1-2, along with a reference silicate cement. The X-ray diffraction analysis was carried out using a scanning speed of 4°/min and a step size of 0.01°, and the results were shown in FIGS. 1-8.

The figures reveal that, in the cement clinkers prepared in Examples 1-6, no diffraction peaks corresponding to free calcium oxide were detected. The absence signifies the successful calcination process achieved at the given temperature. Furthermore, the cement clinkers exhibit a pronounced diffraction peak for C₅S₂$, indicating the successful crystallization of C₅S₂$ under the specific experimental conditions. Additionally, the cement clinkers comprise a highly reactive α-C₂S phase. The α-C₂S phase exhibits greater hydration reactivity compared to β-C₂S and enhances the strength development of the cement clinkers during later stages. In Comparison Example 1, the lower calcination temperature results in subdued diffraction peaks associated with free-calcium sulfate (f-C$) and belite, suggesting their conversion into ternesite through a chemical reaction. The impact of temperature ramp rate on the formation of the cement clinkers is insignificant, as demonstrated through the comparison between Examples 2 and 6. However, in Comparison Example 2, the formation of ternesite is minimal, to the point of being nearly undetectable, which differs significantly from the results observed in Examples 1-6.

Utilizing the XRD patterns, a quantitative analysis of the mineral components within the cement clinkers from Examples 1-6 and Comparison Examples 1-2 was carried out using Topas software and Rietveld full-pattern fitting. The results revealed that the levels of the mineral components in Examples 1-6 aligned with the design specifications. Notably, the content of ternesite reached 42.18 wt. %, demonstrating the feasibility of achieving stable calcination for the belite-ye'elimite-ternesite clinker. The achievement is facilitated through a single calcination process performed within the temperature range of 1210-1250° C., achieved by designing and regulating the content of phosphogypsum in the raw mixture. In comparison, Comparison Example 1 experiences a decrease in the content of cubic ye'elimite and α-C₂S due to the lower calcination temperature. Comparison Example 2 displays lower ternesite content and the presence of C₁₂A₇, while cubic ye'elimite and α-C₂S are not detected. In Examples 1-6, incorporating 2-10 wt. % free-calcium sulfate (f-C$) stimulates the generation of ye'elimite during the early stages of calcination, instead of forming mayenite, calcium aluminate, or other aluminum compounds when calcium sulfate is present. Additionally, the results of quantitative analysis suggest a rise in the proportion of the highly reactive c-C₄A₃$ in Examples 1-6, accounting for about ¼ of the total C₄A₃$ content. The increment contributes to the early-stage strength development of the cement clinker.

### Test for Compressive Strength of Cement Mortar

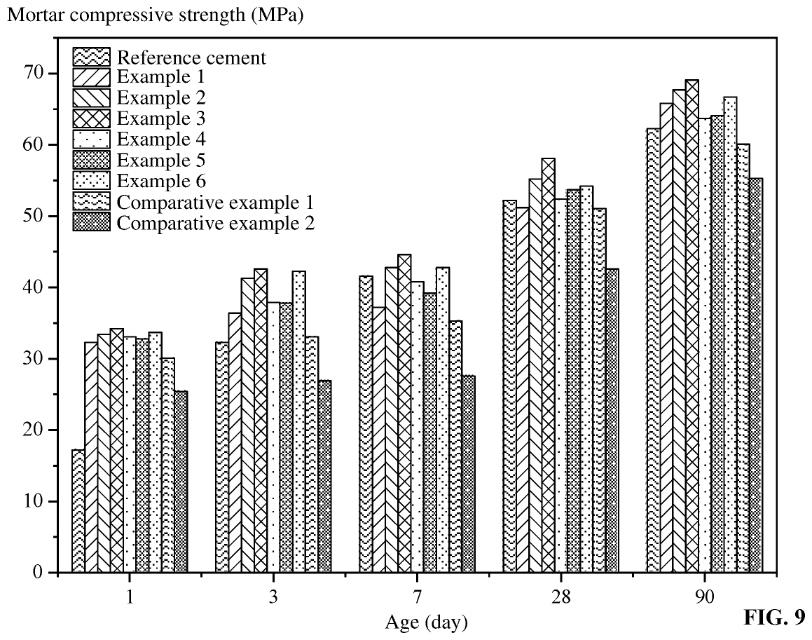

A strength performance test was conducted on the cement clinkers prepared in Examples 1-6 and Comparison Examples 1-2. The resulting cements, derived from the cement clinkers and mixed with a water-to-cement ratio of 0.5 and a sand-to-cement ratio of 3, underwent a test for compressive strength of cement mortar. A reference cement is obtained through combining Portland cement clinker and anhydrite. The reference cement underwent identical test for compressive strength of cement mortar, employing the same water-to-cement ratio and sand-to-cement ratio. The resulting cement mortars were placed within a curing chamber with a constant temperature of 20° C. and a relative humidity of 95%. Subsequently, the compressive strengths of the cement mortars were evaluated at various time intervals. The results for cement mortars at 1 day, 3 days, 7 days, 28 days, and 90 days are detailed in Table 2 and FIG. 9.

TABLE 2
Mortar strength of belite-ye'elimite-ternesite cement prepared
in Examples and Comparison Examples, compared to reference cement

| | Mortar compressive strength/MPa | | | | |
|---|---|---|---|---|---|
| | Reference | | | | |
| Age/d | cement | Example 1 | Example 2 | Example 3 | Example 4 |
| 1 | 17.2 | 32.3 | 33.4 | 34.2 | 33.1 |
| 3 | 32.3 | 36.4 | 41.3 | 42.6 | 37.9 |
| 7 | 41.6 | 37.2 | 42.8 | 44.6 | 40.8 |
| 28 | 52.2 | 51.2 | 55.2 | 58.1 | 52.4 |
| 90 | 62.3 | 65.8 | 67.7 | 69.1 | 63.7 |

| | Mortar compressive strength/MPa | | | |
|---|---|---|---|---|
| | | | Comparison | Comparison |
| Age/d | Example 5 | Example 6 | Example 1 | Example 2 |
| 1 | 32.8 | 33.7 | 30.1 | 25.4 |
| 3 | 37.8 | 42.3 | 33.1 | 26.9 |
| 7 | 39.2 | 42.8 | 35.3 | 27.6 |
| 28 | 53.7 | 54.2 | 51.1 | 42.6 |
| 90 | 64.1 | 66.7 | 60.1 | 55.3 |

The data from Table 2 and FIG. 9, demonstrate that the compressive strengths of the belite-ye'elimite-ternesite cement clinkers, as prepared in Examples 1-6 show significant superiority over those of the reference cement at both 1 day and 3 days. Notably, in Examples 3 and 6, the strengths at 3 days match the 7-day strength of the reference cement. Furthermore, when considering the cement clinkers prepared in Examples 2-6, the strengths at 28 days exceed that of the reference cement, with the exception of Example 1, which shows a slightly lower value. Nevertheless, as time progresses, the cement clinkers prepared in Examples 1-6 exhibit a gradual strengthening effect, eventually surpassing the reference cement in compressive strength at 90 days. The cement clinkers from Examples 2, 3, and 6 demonstrate enhanced strength compared to Examples 1, 4, and 5. This phenomenon can be linked to the theoretically greater reactivity of ternesite compared to belite, where a higher content of ternesite typically corresponds to improved strength performance. However, due to the collaboration hydration process of minerals within the system, there is an optimal range for the mass ratio of belite to ternesite, which lies between 0.25 and 1. Similarly, the mass ratio of ternesite to ye'elimite falls between 0.5 to 1 to achieve optimal strength. Deviating from the ranges often leads to a reduction in strength. Comparison Example 1 shows lower strength, indicating a slightly weaker performance of the cement clinkers calcined at 1200° C. Compared to Comparison Example 2, the strength of the cement prepared using the methods of Examples 1-6 has experienced an enhancement. This improvement highlights a specific performance advantage as described in the disclosure.

It will be obvious to those skilled in the art that changes and modifications may be made, and therefore, the aim in the appended claims is to cover all such changes and modifications.

What is claimed is:

1. A belite-ye'elimite-ternesite cement clinker, comprising:
ye'elimite: 20-50 wt. %;
ternesite: 24-50 wt. %;
belite: 10-35 wt. %; and
free-calcium sulfate (f-C$): 2-10 wt. %.

2. The cement clinker of claim 1, comprising:
ye'elimite: 40-43 wt. %;
ternesite: 24-35 wt. %;
belite: 15-25 wt. %; and
free-calcium sulfate (f-C$): 3-5 wt. %;
wherein, cubic ye'elimite accounts for 9-15 wt. % of the cement clinker;
α-C₂S accounts for 1-3 wt. % of the cement clinker; and
a mass ratio of belite to ternesite is 0.25-1, and a mass ratio of ternesite to ye'elimite is 0.5-1.

3. The cement clinker of claim 2, wherein raw materials of the cement clinker comprise 40-65 wt. % of limestone, 15-30 wt. % of phosphogypsum, 5-20 wt. % of fly ash, and 5-25 wt. % of aluminum source; particularly, raw materials of the cement clinker comprise 48-52 wt. % of limestone, 18-24 wt. % of phosphogypsum, 9-15 wt. % of fly ash, and 18-21 wt. % of aluminum source.

4. The cement clinker of claim 3, wherein
the aluminum source is an industrial waste comprising more than 40 wt. % aluminum; and the industrial waste comprises low-grade bauxite, alumina ash, high-alumina fly ash, or a combination thereof, or
the limestone comprises 50-60 wt. % CaO; or
the phosphogypsum comprises 40-50 wt. % SO₃; or
the fly ash comprises 40-60 wt. % SiO₂ and 30-35 wt. % Al₂O₃.

5. The cement clinker of claim 4, wherein the raw materials of the cement clinker comprise the following main chemical compositions:
limestone comprising 0.61 wt. % of SiO₂, 0.05 wt. % of Al₂O₃, 0.19 wt. % of Fe₂O₃, 55.9 wt. % of CaO, 0.01 wt. % of MgO, and 0.42 wt. % of SO₃, with a loss on ignition of 42.64;
phosphogypsum comprising 1.44 wt. % of SiO₂, 1.19 wt. % of Al₂O₃, 0.62 wt. % of Fe₂O₃, 33.93 wt. % of CaO, 0.31 wt. % of MgO, and 47.04 wt. % of SO₃, with a loss on ignition of 15.45;
fly ash comprising 52.47 wt. % of SiO₂, 34.02 wt. % of Al₂O₃, 2.92 wt. % of Fe₂O₃, 4.80 wt. % of CaO, 0.69 wt. % of MgO, and 0.27 wt. % of SO₃, with a loss on ignition of 2.32;
low grade bauxite comprising 21.72 wt. % of SiO₂, 52.40 wt. % of Al₂O₃, and 7.63 wt. % of Fe₂O₃, with a loss on ignition of 16.00;
alumina ash comprising 27.20 wt. % of SiO₂, 56.16 wt. % of Al₂O₃, 12.49 wt. % of Fe₂O₃, 5.62 wt. % of CaO, 2.80 wt. % of MgO, and 0.78 wt. % of SO₃, with a loss on ignition of −6.01; and
high-alumina fly ash comprising 40.24 wt. % of SiO₂, 48.30 wt. % of Al₂O₃, 2.70 wt. % of Fe₂O₃, 3.17 wt. % of CaO, 0.03 wt. % of MgO, and 0.64 wt. % of SO₃, with a loss on ignition of 2.16.

6. A method for preparing the cement clinker of claim 1, the method comprising:
(1) individually grinding the raw materials of the cement clinker; weighting the ground raw materials according to mass percentages; thoroughly mixing the ground raw materials to obtain a raw mixture; pressing the raw mixture into a cake and then drying the cake to obtain a raw clinker cake; and
(2) calcining the raw clinker cake; cooling the calcined raw clinker cake to room temperature; and grinding the cooled raw clinker cake to obtain a cement clinker.

7. The method of claim 6, wherein in (1), the raw materials are ground to a particle size of ≤0.075 mm; or the ground raw materials are thoroughly mixed for 6-9 hours using a mixer.

8. The method of claim 7, wherein in (2), calcining the raw clinker cake comprises heating the raw clinker cake to a temperature of 1200-1250° C. at a heating rate of 5-10° C./min, and maintaining the temperature for 60-120 minutes.

9. Belite-ye'elimite-ternesite cement, comprising the belite-ye'elimite-ternesite cement clinker of claim 1 or the belite-ye'elimite-ternesite cement clinker prepared by the method of claim 6, and calcium sulfate.

10. The cement of claim 9, wherein an amount of calcium sulfate is calculated according to a molar ratio of ye'elimite within the cement clinker to SO₃ contained in the calcium sulfate and subtracting the amount of free-calcium sulfate (f-C$) in the cement clinker; the molar ratio of ye'elimite within the cement clinker to SO₃ contained in calcium sulfate is determined according to the specification of the cement; and/or, the calcium sulfate comprises phosphogypsum, gypsum, anhydrite, desulfurization gypsum, or a combination thereof.
